(19) United States
(12) Patent Application Publication
(10) Pub. No.: US 2006/0291558 A1
(43) Pub. Date: Dec. 28, 2006

(54) Method and arrangements for processing video signals

(75) Inventors: Ralf Michael Schreier, Ulm-Ermingen (DE); Albrecht Rothermel, Neu-Ulm (DE)

Correspondence Address: Alan L. Carlson, 6202 Lynn Lane, Lago Vista, TX, 78645, US

(73) Assignee: On Demand Microelectronics

(21) Appl. No.: 11/473,809

(22) Filed: Jun. 23, 2006

(30) Foreign Application Priority Data
Jun. 23, 2005 (DE) 10 2005 029 127.9

(51) Int. Cl. H04N 11/04

(52) U.S. Cl. 375/240.13

(57) ABSTRACT

In accordance with the present disclosure, refresh patterns can be proposed for video data having motion and distortion estimation data for the proposed patterns can be determined based on motion data. An acceptable refresh pattern from the proposed refresh patterns can be selected and utilized. Such a “tailored” pattern that is dynamic and can change quickly, can cater to the direction of motion of the video to provide low distortion and high quality video.

### BACKGROUND

1. Field of the Disclosure

The present disclosure is generally related to the processing of a video signal and to systems and methods for processing intra-coded and inter-coded video data

2. Background of the Invention

Video compression is a process where, instead of transmitting a fill set of data for each picture element or pixel on a display for each frame, a greatly reduced amount of data can be coded, transmitted and decoded to achieve the same perceived picture quality. Generally, a pixel is a small dot on a display wherein hundreds of thousands of pixels make up the entire display. A pixel can be represented in a signal, as a series of bits or as binary data. Compression of data often utilizes the assumption that, data for a single pixel can be correlated with a neighboring pixel within the same frame and the pixel can also be associated with itself in successive frames. A frame is a segment of data required to display a single picture or graphic and a series of consecutive frames are required to make video. Since the value of a pixel is predictable using neighboring pixels and pixels in consecutive frames, most video encoders use a two-stage hybrid coding scheme to compress and decompress video signals. Such a hybrid process combines a spatial transform coding for a single frame (reproducing pixel data based on neighboring pixels) with temporal prediction for the succession of frames (reproducing pixel data as how it changes between frames).

Spatial transform coding can reduce the number of bits used to describe a still picture. Spatial transformation or intra-coding can include transforming image data from spatial domain into a frequency-domain utilizing a DCT transformation, wavelets or other processes. Then, the resulting coefficients can be quantized where low-frequency coefficients usually have a higher precision than high frequency coefficients. Afterwards, loss-less entropy coding can be applied to the coefficients. By using the transform coding, significant lossy image compression can be achieved whose characteristics can be adjusted to provide a pleasing visual perception for viewers.

Likewise, temporal prediction in streaming video can provide intracoded frames to establish a baseline refresh, and then successive frames can be described digitally by their difference to the previous frame. This process is referred to as “inter-coding.” The “difference” data or signal which has significantly less data than the fill data set, is usually transformed and quantized similar to the intra-coded signal but with different frequency characteristics. Inter-coding can provide superior results over intra-coding if motion compensated prediction is combined with inter-coding. In this case, an unrestricted texture region in a previous frame is searched to locate an area which matches as closely as possible the texture of an area to be coded for a current frame. Then, the difference signals and the calculated motion can be transmitted in an inter-coded format. Traditional systems often restrict certain regions from being utilized as baseline data to reduce error propagation. All such encoding (i.e. intra-coding and inter-coding) is often referred to generically as data compression.

Inter-coded transmissions utilize predicted frames, where predicted frames occur when the full set of data is not transmitted, but information regarding how the frame differs from a previous frame is utilized to “predict” and correspondingly construct the current frame. As stated above, intra-frame encoding is the creation of encoded data from a single image frame where inter-frame encoding is the creation of encoded data from two or more consecutive image frames. The temporal prediction of frames is theoretically lossless, but such prediction can lead to a serious degradation in video quality when transmission errors occur and these transmission errors get replicated in consecutive frames. For example, if an error occurs in some content and subsequent transmissions rely on the content to predict future data, the error can multiply causing widespread degradation of the video signal. In order to avoid infinite error propagation, intra-coded reference frames can be utilized to periodically refresh the data The intra-coded data can be decoded “error-free” because it is independent of the previous possibly corrupt frames. Furthermore, the intra-coded frames can be used as an “entry point” or start point for decoding a compressed video data stream.

Alternately described, if a frame that is utilized as the reference point for other pixels has an error, this error will often be propagated throughout the video resulting in a poor quality picture. Distortion often results from errors and inaccurate reproductions of data which may be caused by transmission errors on error-prone channels and motion of an object on the screen further adds to distortion problems. Generally distortion is the undesired change in the digital data resulting in the loss of clarity in such reproduction.

A macroblock is a block of data that describes a group of spatially adjacent pixels. A macroblock usually defines pixels in a rectangular region of the screen where the data in a macroblock can be processed together and somewhat separately from other macroblocks. Thus, a frame can be divided into numerous macroblocks and macroblocks are often defined in a matrix topology wherein there are x and y macroblocks and wherein a macroblock can have a designation as (2, 3) and so on where x and y can range from 1 to Z. In some popular applications like video telephony which require low transmission latencies, the above-described standard Internet protocol (IP)-coding method cannot be applied because it would probably cause unacceptable delays and thus a poor quality of video. As the periodically transmitted intra-coded frames are significantly larger than intra-coded frames, a large buffer can be provided to smooth out this variable data rates over time. It is therefore a common practice to embed intra-coded regions sequentially into predicted frames rather than transmit a complete frame of intra-coded data. As the rate variations between successive frames are reduced, the buffer latencies can be reduced with such a process.

In such traditional hybrid compression applications, predicted frames have a relatively constant amount of intra-coded macroblocks transmitted sequentially in a pre-defined pattern (e.g. from top to bottom or left to right of the display). As stated above, a significant problem with hybrid compression systems is that a prediction based inter-frame coding that is based on an old frame possibly having errors, (a frame which has not been recently refreshed or has only been partially intra-refreshed), often creates an obtrusive picture. If any motion compensated prediction is utilized with the hybrid system, undesired prediction based on obsolete regions often occurs. In addition, existing frame errors can spread from obsolete or old regions into new or refreshed image regions. In order to overcome this problem some restrict the motion estimation search area utilized in inter-coded regions, to regions that have been recently refreshed. In practical applications, restricting the search area results in frequently intra-coded macroblocks along the borders of refreshed image regions, which generate a higher amount of data than required by a standard prediction procedure. Additionally, if an unfortunate refresh order is chosen, (for example if the refresh is in an opposite direction of an object motion) the resulting intra-coded border regions of the display will typically lead to an increased data rate of 5 to 15% and to a decreased image quality. Since only a certain bandwidth or data rate is available poor quality video can result.

Other methods attempt to achieve an “error-free” image or video by sequentially transmitting intra-coded image regions by overlapping regions. By overlapping the intra-coded regions by at least the size of the temporal prediction search range, the prediction from the old or obsolete region to new regions can be prevented. However, because of the overlapping regions, a higher number of intra-coded macroblocks are required and this also results in a much higher data rate. Some attempts have been made to use statistical methods to provide motion adaptive intra-coded refresh methods but such methods typically provide unacceptable distortion. More specifically, these methods do not provide an error-free display in a pre-defined time interval because of their non-deterministic refresh pattern. Significant distortion can result from such a random refresh process.

### BRIEF DESCRIPTION OF THE DRAWINGS

FIG. 1 is a diagram of an embodiment the illustrates a refresh cycle for a frame,

FIG. 2 is a diagram that illustrates how a direction of motion creates a border region;

FIG. 3 is a diagram that illustrates how a direction of motion can be oriented in relation to an old region and a new region;

FIG. 4 is a block diagram of a video processor with video compression components;

FIG. 5 is a chart of possible assignment of macroblocks to regions from a mapping memory;

FIG. 6 is a chart of possible refresh patterns;

FIG. 7 is a flow diagram for a video compression method;

FIG. 8 is a flow diagram that illustrates a way to calculate the average motion of all regions in a frame;

FIG. 9 is a flow diagram that calculates distortion and selects a refresh pattern;

FIG. 10 is a flow diagram that illustrates calculating the distortion parameters for a given region; and

FIG. 11 is a flow diagram that illustrates encoding frames with refresh data

### DETAILED DESCRIPTION OF THE DRAWINGS

The following is a detailed description of novel embodiments depicted in the accompanying drawings. The embodiments are in such detail as to clearly communicate the subject matter. However, the amount of detail offered is not intended to limit anticipated variations of the described embodiments, but on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art. Generally, methods and arrangements for processing video including coding video data for refreshing a video display are disclosed herein. While specific embodiments will be described below with reference to particular circuit or logic configurations, those of skill in the art will realize that embodiments may advantageously be implemented with other configurations.

In accordance with the present disclosure, refresh patterns can be proposed for video data having motion and distortion estimation data for the proposed patterns can be determined based on motion data. An acceptable refresh pattern from the proposed refresh patterns can be selected and utilized. Such a “tailored” pattern that is dynamic and can change quickly, can cater to the direction of motion of the video to provide low distortion and high quality video.

In one embodiment a method for refreshing a display with video data is disclosed. A video frame can be divided into a plurality of non overlapping refresh regions. At least one priority region from the plurality of refresh regions can be selected to receive an intra-coded refresh transmission, the selecting can be based on a parameter such as a distortion parameter. The video frame can be transmitted to provide the intra-coded transmission to the at least one priority region. The selecting can be done dynamically based on a distortion parameter for each frame. The method can further include obtaining baseline data for the priority new regions only from a new region. This can be achieved when a motion is in a direction of an old region. In another embodiment, the system can provide inter-coded transmissions to non-priority regions utilizing data from an old image region to create the inter-coded data for a new image region based on parameters of motion estimation such as a direction of motion away from old regions. The distortion parameter can be based on motion and which regions are old and which region are new.

In another embodiment an apparatus for providing video data is disclosed. The apparatus can include an inter-coded data generator to create predictive data, an intra-coded data generator to create refresh data, and a multiplexer to multiplex the inter-coded data with the intra-coded data. The apparatus can also include a calculator to calculate at least one parameter of the video data, a mapping module for mapping the video data into non-overlapping regions; and a frame refresh controller to determine a refresh pattern of inter-coded data and intra-coded data based on the calculated at least one parameter.

In yet another embodiment a video system is disclosed. The video system can include a transmitter to transmit a compressed video signal having intra-coded transmissions mapped into non-overlapping predetermined regions based on calculated parameters and a receiver to receive the intra-coded transmissions and to decode the compressed video into a decompressed video signal. The video system can also include a display to display a representation of the decompressed video signal.

As stated above many video compression methods refresh a display from left to right and/or from top to bottom. In accordance with the present disclosure refreshing a display is disclosed utilizing intra-coded transmissions in strategic locations and at strategic intervals to regions having a priority status. Such strategic placement of intra-coded refresh transmissions can be achieved with data transmission having a more uniform bandwidth requirement than traditional hybrid compression systems and thus the methods and arrangement provided herein can provide improved picture quality over traditional left to right up to down refresh schemes.

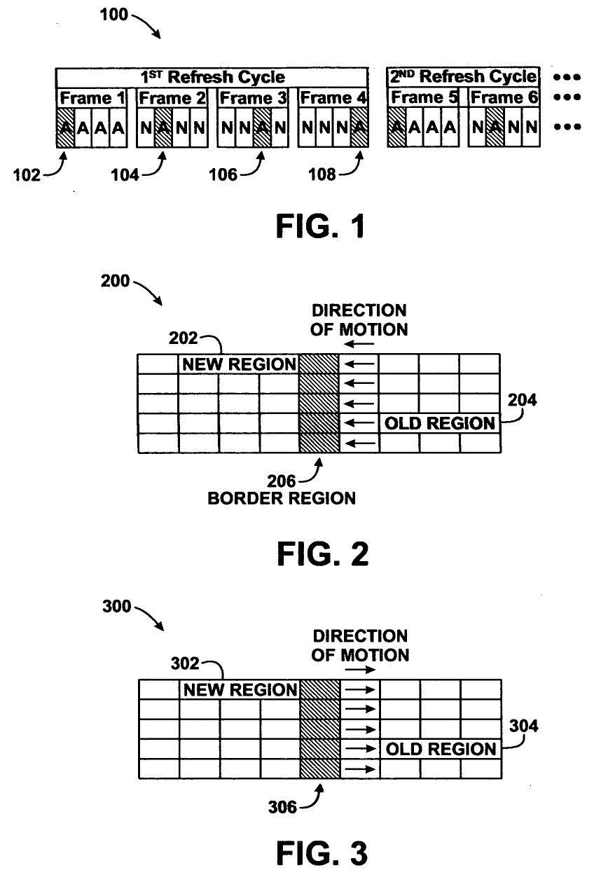

Referring to FIG. 1, a block diagram 100 of one and a half refresh cycles is disclosed. The first refresh cycle is divided up into four frames, one for each of the four regions to supply the four segments on the display. Although in FIG. 1, a frame has been separated into four distinct regions, a frame could be split into more regions or less regions depending on the desired quality of the picture, the size of the display size, the available bandwidth and many other factors.

Thus, frame 1 102 can provide the data for one fourth of the display area. In the block diagram “A” with cross hatching indicates an intra-coded region from an old region, “A” without cross hatching indicates a predicted or inter-coded frame region from an old region, and N indicates a predicted frame region of inter-coded frame region based on a new region. Thus, the presence of “A” generally indicates an old region.

The block diagram 100 illustrates an iteration where the intra-coded data refreshes the display and regions can be tagged as old regions at the beginning of a cycle and be tagged as new regions after an interspersed intra-coded refresh transmission is made to the region. Thus, the refresh cycle provided, transmits a intra-coded region denoted by “A with a cross hatch” in the first region in frame one, in the second region in frame two, the third region in frame three and so on such that when the fourth frame is displayed the entire display has been refreshed by an intra-coded transmission and the frame should be substantially “error-free” after transmission of the fourth frame. The number of frames in a refresh cycle can be dictated by how many regions are defined on the display, thus N regions can have a refresh cycle with N frame transmissions. After the intra-coded transmission is made then the region receiving the transmission can be tagged as a “new” region and new regions can remain new regions until the end of the refresh cycle. Then all regions can be set or tagged as old regions as the process starts over.

Accordingly, a frame can be split into N non-overlapping refresh regions depending on the design goals. In accordance with the present disclosure, instead of transmitting intra-coded data to every region in a single frame in an attempt to “instantaneously” refresh a screen one or more refresh regions can be sent intra-coded during each frame transmission, and in N or less frames, a complete refresh can occur. In a complete cycle a whole frame can be refreshed by intra-coded transmissions that occur at strategically selected times and places.

A new refresh cycle can start with estimating or trying to determine a strategic and possibly “optimal” sequence to provide intra-coded data to selected regions during the cycle. This strategic sequence can label regions as priority regions where these regions are selected for a refresh (an intra-coded transmission) for a given frame transmission. Since either is no motion or distortion data available during start up, the system can choose from a pre-defined set of refresh sequences or a refresh pattern such as the pattern described in FIG. 1 which is known to provide acceptable results. Then, during operation or after a few frames have been transmitted, a strategic sequence can be determined dynamically based on calculations such a distortion calculations made on successive frames of data in an ongoing process.

The strategic refresh pattern or sequence can be calculated prior to every refresh cycle. Such a calculation can be based on motion and a motion distortion parameter can be calculated in a step-by-step process. In one embodiment the calculation can be made utilizing data at the border of the old and new image regions or around a region receiving an intra-coded transmission. In one embodiment, the refresh pattern or intra-coded transmission pattern that provides the lowest estimated/calculated distortion can be utilized to determine priority location in the “next” refresh cycle. Such a refresh pattern can be accomplished with a minimal increase in bandwidth and a significant improvement in the quality of video that is displayed. The lowest estimated distortion can be a calculated estimate of distortion at critical or “busy” locations on the display. Generating data based on old data and in regions of motion can cause a high estimated distortion. At the start of a refresh cycle all regions of a display can be tagged as old regions and when a region receives an intra-coded transmission or is refreshed the region can be tagged as a new region.

The method is exemplarily illustrated in FIG. 1 for a refresh cycle with four frames. In every frame a vertical strip of roughly equal size is transmitted in intra-coded mode, i.e. without temporal prediction, whereas the other regions of the frame are inter-coded using the temporal prediction. At the start of a refresh cycle all regions belong to the group of “old regions.” When a region was transmitted in intra-coded mode, it is re-assigned to the group of “new regions”

In addition existing frame errors can spread from obsolete into “new” frame regions. In order to overcome this problem some have suggested restricting the motion estimation search area for “new” image regions to “new” image regions. In practical applications, restricting the search area results in frequently intra-coded macroblocks along the borders of “new” image regions, which generate higher a higher amount of data than predicted macroblocks. It would be beneficial to avoid such a strain on bandwidth. As will be discussed with reference to FIG. 3, the occurrence of intra-coded border regions can be avoided utilizing the teachings herein because the matching direction of the intra-coded refresh and temporal prediction avoids the undesired prediction using old regions to baseline new image regions.

Referring to FIG. 2, a frame 200 that is in the middle of a refresh cycle is illustrated. The graphics of FIG. 2 are intended as a zoom into a border area of a new and old region 202 and 204 respectively. The small squares represent macroblocks. All of the macroblocks on the right side of the border region belong to a common “old” region 202, and similarly all the macroblocks on the left side of the border region belong to a common “new” region 204. The old and new regions are both inter-coded and some other regions in the frame may be getting refreshed with intra-coding during the time period being illustrated. The border region 206 contains macroblocks belonging to the new region which were intra-coded due to a restricted motion search range. The direction of motion can be assumed to be constant throughout all macroblocks of FIG. 2 and this is illustrated by the arrows pointing right to left or from the old region 204 to the new region 202.

Distortion is typically highest between new and old regions and in accordance with the present invention distortion calculations can be concentrated in this border region. If the motion estimation search range is restricted in the proximity of the borders of new regions, the “mode decision module” of a traditional video encoder will often determine that irregular data exists. If a good reference data for inter-coded data cannot be located (e.g. it is outside the picture or it the search range is too small) the boundary of the frame can be intra-coded to create a higher quality of video. It may also be possible to find a similar texture or good reference data in other areas or other frames, but such an encoding process will generally increase the data rate. This occurs because the match of the texture will typically not be as perfect as it would be when reference data is acquired proximate to the subject location.

As indicated by the motion arrows, the motion in the border region is pointing from the old region 204 to the new region 206. Thus, traditional encoders would utilize reference data from the old region 204 for the border region. As the search range for motion prediction and/or reference data is restricted to the new region 206, the best source for the data cannot or may not be found as it may be located in the old region 204. Thus, the border macroblocks 206 which should be inter-coded are frequently intra-coded in traditional compression methods.

Referring to FIG. 3, a frame 300 that is in the middle of a refresh cycle is illustrated, wherein the direction of motion has changed with respect to FIG. 2. The new region 302 that has been refreshed, is separated from the old region 304 by a border region 306 belonging to the new region. In FIG. 3, the direction of motion of an object on the screen, or an object boundary is progressing in the same direction as the refresh pattern. The motion of an object can be continuously monitored or measured as stated above and an adequate source of prediction data can be found for all macroblocks. Hence the border region 306 can be coded in inter-mode as the source of reference lies within the new region.

In accordance with the present disclosure, although the search range for reference data for a new region can be restricted to new regions, it can be determined that this is not critical in certain instances when an old region is not needed for forming an adequate reference data for a new region. Features provided herein to determine when new and old regions should be restricted when locating reference data can include considering distortion and motion. The motion estimation of the old region can be unrestricted (allowed for usage as baseline reference data) and sections of the new regions may be unrestricted for predicting old regions.

As stated above, distortion can be a factor in determining a priority region or priority regions that determine a strategic refresh pattern. In the transmission of one or more successive frames, the dominating direction of motion for each refresh cycle can be determined analytically. Motion vectors of the temporal predictor may be used to calculate or estimate a direction of motion or in some cases a dominating direction of motion. Such direction of motion and old/new information can be important in focusing calculations that can determine strategic refresh patterns that minimize the effects of restricted activities.

In accordance with the present disclosure, refresh patterns can be proposed for video data wherein motion data and distortion estimation data can be derived from the video data. An acceptable, a preferred or a best refresh pattern can be determined by testing the proposed refresh patterns. The best refresh pattern can be utilized to provide low distortion and high quality video.

The distortion S can be calculated based on motion data. When the dominating direction of motion in an old region, points in the direction of a neighboring new region as illustrated in FIG. 2; S can be defined as S>0. For all other cases such as the case of FIG. 3 where the direction of motion is towards an old region S can be set to 0 or S=0. Thus, when a direction of motion is being “followed” by refreshing regions the distortion can be negligible and when the direction of motion is towards a new region obtrusive video can result.

When calculating the distortion of a proposed refresh pattern for each frame the distortion S along all neighboring refresh regions or border regions can be calculated according to the above definition. The distortion calculation can be accumulated across a number of frames. After a predetermined amount of frames, the overall distortion can be calculated by accumulating the distortion of the individual frames. The overall-distortion can be calculated for all possible refresh patterns or combinations of intra-coded transmissions with inter-mode transmissions. In one embodiment the prediction of new frame regions (or creation of new frames) based on data from old frames can be prohibited particularly when the motion is in the direction of the old regions. This mode can be referred to as “enabled border protection”, as the borders of new regions are actively protected against damages by possibly corrupted data from old regions. This prohibition will reduce the data errors created during the display of the video even if a failure has occurred after a complete refresh cycle. By controlling the sequence of intra-coded refreshed regions according to motion information, the increase of the data rate of traditional methods along the borders of new refreshed regions can be avoided. Thus, strategic dynamic placement of intra-coded transmissions in frames or refreshing areas based on intra-coded activity and “freshness” of data can provide a significant improvement in the quality of video with a reduced bandwidth

Additionally, the dynamic placement of intra-coded transmissions can eliminate the requirements in traditional systems requiring a sequential refresh process and a process that prohibits prediction utilizing old areas to create a new image region The disclosed system can determine an “optimal” or acceptable refresh sequence for an intra-coded refresh. Such a sequence may refresh regions ahead of the direction of motion which can minimize error propagation that occurs when utilizing old reference frames to create data for new regions. Under certain circumstances, small errors in the frame might be left after a complete refresh cycle due to the utilization of old frames that are not in the direction of motion however, this is minimal and this mode can be referred to as “disabled border protection”. as the borders of new regions are not forcibly protected but the possible corruption of data is minimized.

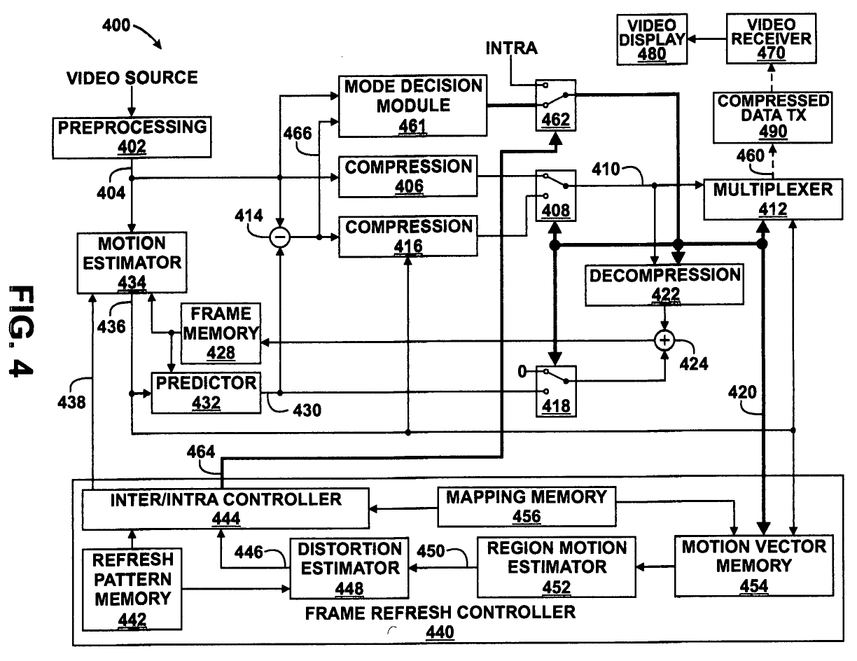

Referring to FIG. 4 a block diagram of a dynamic refresh video encoder 400 is depicted. Traditional hybrid video encoding can be provided by components 402-436 and 461 and in accordance with the present disclosure, strategic intra-coded transmissions can be controlled by strategic refresh controller 440 with the assistance of various other components such as components 438-456 and components 462-464. The dynamic refresh video encoder 400 can have a transmitter 490 to transmit wire line or wireless signals to a video receiver 470 that can display the video on a display 480. The wire line signal could travel over the Internet in an Internet protocol format.

The dynamic refresh video encoded 400 can include calculator modules that can calculate various trends in, or parameters of, the video data. In operation, a digitized video signal can be provided to the input of preprocessor 402 as a continuous video data stream. The data can be re-scaled by the preprocessor 402 module to create the required resolution and color format. The processing and calculations can be performed on a pixel image region or a macroblock, of nearly any size. Macroblocks can be processed in sequential order and the image information of a macroblock of a current frame can be supplied as a signal at node 404. The compression without temporal prediction (intra-coding) can be performed by compressor 406, which can integrate, for example a 2-dimensional DCT, a frequency adaptive lossy quantization and a lossless entropy coding stage.

For a more efficient predictive coding mode (inter coding), a calculator such as the motion estimator 434 can calculate a motion vector using the image data from the last reconstructed frame(s) in frame memory 428 and the current image data at node 404. The motion vector on line 436 represents the displacement of image regions (i.e. macroblocks) in horizontal and vertical directions. The motion vectors on line 436 can be passed to the predictor 432 which can move the image information in frame memory 428 according to the motion vector on line 436.

The motion estimator 434 can calculate the spatial displacement of a macroblock taken from the current frame with respect to the previous frame by means of correlating the pixel data inside of the macroblock at several search positions. If the video sequence is static and no motion is present, the motion estimator should return a (x,y)=(0,0) displacement vector for the macroblock and the predictor will use the pixels at the identical position of the previous frame for forming the inter-coded data of the current frame. Motion searches are computationally very complex and generally beyond the scope of this disclosure, however results from such a search can assist in providing higher quality video. An area in which the motion estimator searches for the best reference in the previous frame is usually limited to a small reference window which is defined by a “search range.” For example, a search range of 16 pixels in all directions means, that the motion estimator can search reference data in a square area around the center of the macroblock with a maximum x and y distance of 16 pixels.

For the normal inter-coding, a rectangular search window is assumed according to the description above. The search window does however not have to be square and symmetrical and it is also possible to exclude certain areas from the reference window or from the search range. In the context of this disclosure the term “restricted search range” can describe the fact, that the motion estimation process of a macroblock in the new region can be limited to a search window which only includes pixel data of new regions in the reference window. Restricting the search range can either be achieved by setting appropriate parameters in the motion estimator prior the motion estimation process or by performing un-restricted motion estimation and rejecting the calculated motion vector in case it would result in usage of reference data which is inaccurate or not allowed.

In one embodiment the motion estimator 434 can only calculate motion vectors at integer pixel positions. Hence if a macroblock has a size of m by n pixels, the predictor 432 can utilize a m by n pixels cut-out of the reference frame from frame memory 428 to generate the signal 432. If the current macroblock belongs to a new region and the integer part of the motion vector indicates that data from a neighboring old region is used to form the prediction of this macroblock, this can be referred to as a “primary source of distortion”.

In another embodiment the motion estimator 434 can calculate motion vectors with fractional pixel positions. This is achieved by up-interpolating the pixel data in the reference memory 428. However, the interpolation process may use data from surrounding pixels. If the macroblock has a size of m by n pixels, and the motion estimator has calculated a motion vector with a fractional precision, the predictor 432 may use data from the frame memory 428 which is outside the original m by n pixel reference area.

If the current macroblock belongs to a new region and the integer part of the motion vector indicates that no data from an old region is used (i.e. no primary source of distortion), but the prediction of fractional pixel positions requires usage of pixels from an old region this can be referred to as a “secondary source of distortion”.

Thus border protection can be enabled for non-priority regions such that when a motion is on a direction of an old region, the amount of reference data from old regions utilized to encode the inter-coded transmission can be reduced by such border protection. For example, more than one frame can be utilized to obtain region motion information and this multi-frame motion information can be utilized to reduce the effects of border protection by allowing some old frames to be utilized for reference data. In another embodiment, macroblocks can be grouped into regions and motion data for the plurality macroblocks or the region can be utilized to reduce the effects of border protection. In yet another embodiment, primary sources of distortion can be located or estimated and the primary sources of distortion can be avoided when generating inter-coded data for the non-priority regions.

Then, the output signal on line 430 of the temporal predictor 432 is subtracted from the signal on line 404 using subtractor 414 and passed to the compressor 416. The compressor 416 can perform basically the same data reduction as compressor 406 but the parameters for quantization and entropy coding can be selected differently. Additionally, the motion vectors on line 436 of the current macroblock can be compressed without losses and appended to the data stream before the output signal is passed to switch 408.

The switch 408 can select between the intra-coded output signal of compressor 406 and the inter-coded output signal of compressor 416 controlled by a signal on line 420. The multiplexer 412 can add the information of the applied coding mode (denoting intra or inter-coding mode) to the compressed image data received on line 460 to the data stream at output 460 for transmission to a compressed data transmitter 490. A video receiver 470 can receive and decode the video to drive display 480.

Generally, when the intra/inter controller 444 does not force switch 462 to provide an intra-coded macroblock, the mode decision module 461 can control the timing and placement of intra-coded and inter-coded transmissions via switch 408. In one embodiment the input signals of the compressors 406 and 466 can be evaluated as part of the mode decision via line 466, and switch 408 can be controlled accordingly.

In one embodiment, the motion estimator 434 will not utilize old frame regions (or restrict the search) to create reference data to predict new regions particularly when the region motion estimator 452 can determine that motion in the video data is in a direction of the old region. Thus, the output of the intra/inter controller 444 to the motion estimator 434 can control what frame regions are utilized to create inter-coded data.

When there is a motion estimation/prediction failure the mode decision module 461 can decide to intra-code macroblocks which would normally be inter-coded. A failure can happen for many reasons, for example if a moving object reveals a background texture that did not exist in a previous frame. Many decisions based on phenomena like failures can be accomplished in numerous ways and the exact operation of the mode decision module 461 should not be utilized to limit the scope of this disclosure.

In one embodiment, mode decision controller 461 can decide on intra-coding regions in response to a signal from intra/inter controller 444 sending a signal to motion estimator 434 to restrict the search range for motion and for refresh data to new regions. This can occur when the original refresh data cannot be located because it is in an old region outside the search range. In one embodiment intra/inter controller 444, motion estimator 434 and mode decision controller 461 work independently to a large degree. The impact of intra/inter controller 444 on mode decision module 461 is indirect and could be undesirable.

The switching data on line 464 can control the forced insertion of intra-coded macroblocks to the multiplexer 412. In normal encoder operation, the output of mode decision module 461 can be connected to line 420 via switch 462 and the mode decision controller 461 can control/determine the coding mode. If strategic refresh controller 440 signals for an intra-coded block via line 464, this will override the mode decision controller 461 by controlling switch 462 to provide intra-coded data to the multiplexer 412 and the decompressor 422.

In accordance with the present disclosure, to avoid an accumulation of compression errors by compressor 406 and compressor 416, temporal prediction processes performed by predictor 432 can utilize a decompressed video signal via decompressor 422. The decompressed video signal can be generated from the compressed output stream on line 410 by decompressor 422 to supply the decompressed signal to adder 424. Decompressor 422 can perform the decompression of image data according to the same methods utilized by compressors 406 and 416. To reconstruct an intra-coded macroblock, switch 418 can feed a null-signal to the adder 424, otherwise the output signal at node 430 of the predictor 432 can be utilized to reconstruct the intra-coded data. The reconstructed image signal on line 426 can be stored in the frame memory 428 for one frame duration.

In accordance with the present disclosure, the strategic refresh controller 440 can control the operation of an intra-coded refresh cycle based on parameters of the video data. These parameters can be calculated during video processing. For example, an average motion of all regions, a distortion, distortion at a boundary of motion, a boundary between old and new regions, and an overall distortion to name a few can be calculated and utilized to encode data. The overall distortion can be determined by calculating a distortion for a plurality of individual frames and adding the distortion of the individual frames. Additionally, a direction of motion and a change of a dominating direction of motion can be utilized to create or calculate parameters. In one embodiment, parameters of motion estimation can also be utilized to determine whether old regions and new regions should be restricted (prohibited from a search) or unrestricted (available as reference data to predict or construct compressed data.)

In accordance with one embodiment, the strategic refresh controller 440 can control the operation of an intra-coded refresh cycle based on motion vectors. The motion vectors on line 436 that are calculated for the predictive coding (performed by predictor 432) can be stored in the motion vector memory 454 and passed to the region motion estimator 452. The region motion estimator 452 can determine which macroblocks are assigned to which refresh regions by looking up the macroblock/refresh assignments in mapping memory 456. The region motion estimator 452 can generate a signal on line 450, that describes the dominating direction of motion for a given regions based on the macroblock designation

Distortion can be described generally, as an unwanted change in a video signal due to inaccurate reproduction of the original signal based on less than perfect recreation of the signal during decompression. As stated above, the system 400 can distinguished between regions tagged as new image regions (recently refreshed with an intra-coded transmission) and old image regions that may contain stale data or contain error-ridden data, and refrain from utilizing old regions based on a direction of motion in the region being processed.

The frame refresh controller 400 can obtain motion information including motion vectors from the predictive coding stage 434. Thus, the motion information can be utilized to minimize distortion caused by prediction from basing new image regions on old image regions. Distortion and distortion parameters discussed herein can refer to an estimate of possible distortion. Under normal operating conditions if no transmission errors occur and the system is up and running, typically there will not be any visible distortion in the moving image. Hence, the system 400 can operate on the assumption that there may be visible distortion and express the possible impact of the distortion parameters. The output 464 of the system 440 can force intra-coded transmissions, but the mode decision 461 can also insert other intra-coded macroblocks if the prediction does not work effectively.

Under certain circumstances the refresh cycle can be aborted if a sudden change in the dominating motion or the image content occurs. In this case a new refresh cycle can be restarted. If a refresh cycle was completed, a new refresh cycle can start with determining a strategic pattern for the intra-coded transmissions. Alternatively, one or more predicted frames may be transmitted without intra-coded refreshing regions.

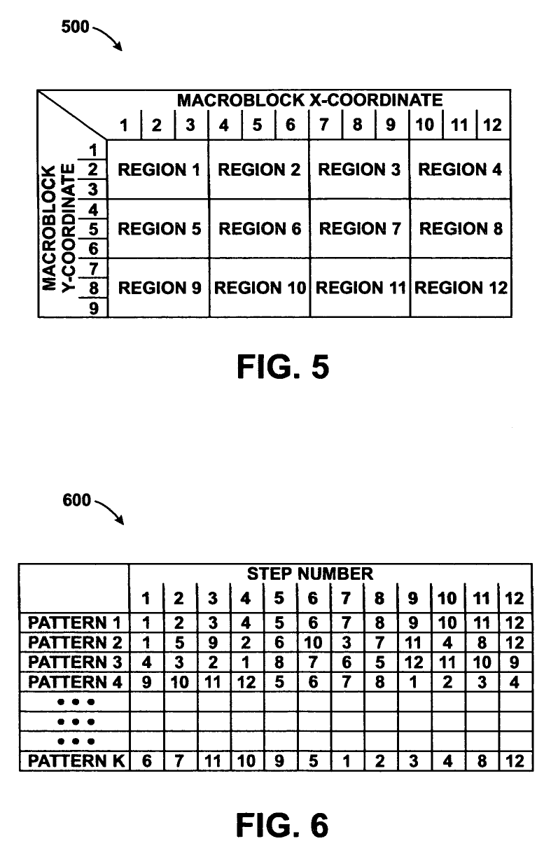

Referring briefly to FIG. 5, a possible initialization scheme 500 for starting the video display is illustrated. The mapping memory 456 of FIG. 4 can store and provide such initialization data. The example of FIGS. 5 and 6 have frames that are divided into 12 regions. As illustrated, the regions can have “x” and “y” macroblock coordinates that define their position in regions of the frame. The mapping memory 456 can also be utilized to assign small frame regions to a larger refresh region. A mapping memory procedure can provide a flexible way to group macroblocks into regions. Generally, working directly on macroblock data to refresh an image instead of working with regional data could be performed; however in many instances this can significantly increase the complexity of process.

The mapping memory can be a static table that provides mapping of macroblocks into regions. Utilizing macroblock coordinates where macroblock_x=[1 . . . mb_x_max] and macroblock_y=[1 . . . mb_y_max], the mapping memory can return an index of the region where the macroblock resides. The index could also be provided or defined and/or generated with a mathematical mapping equation or algorithm. Although the assignment of macroblocks to areas is usually static for the duration of a complete refresh cycle, these assignments can change possibly every refresh cycle if warranted.

Referring back to FIG. 4, the refresh pattern memory 442 can store pre-defined or predetermined refresh patterns, which provide sequences in where the intra-coded regions can be strategically transmitted to achieve a complete frame refresh Possible initialization sequences for frames are illustrated in the chart of FIG. 6. By defining a small set of K refresh patterns (about 30 have proven to be sufficient for an N=12 region refresh), the complexity of selecting the strategic refresh sequence out of N frames is N factorial or N!=479*10⁶ for N=12. Thus, possible sequences for refreshing the frame are dramatically reduced. Further, the refresh pattern memory can be utilized to store a pre-defined set of two or more different refresh sequences and these refresh sequences can be utilized effectively regardless of the distortion or motion data for starting up the system or in other circumstances where no distortion measure or means is available.

Generally, two previous frames are needed to provide an accurate calculation of an average motion estimate, because one frame will usually have some intra-coded macroblocks for which no motion information is available. However, it is also possible to calculate motion vectors for intra-coded macroblocks which are only used for the intra-coded refresh adaptation. The number of previous frames used for the calculation can be user selected is a matter of parameter selection. There are many other ways to obtain/calculate motion information and other methods of obtaining motion information would not part from the scope of the present disclosure.

The refresh pattern memory 442 can also provide a static table that stores pre-defined or predetermined refresh patterns. The refresh pattern memory 442 can be accessed utilizing a pattern_index=[1 . . . K] (e.g. the optimal pattern K_opt) and a frame number in a refresh sequence “step”=[1 . . . N]. If the pattern_index is a constant, counting step form 1 to N can provide a read out of the sequence of refresh areas for the specific pattern, which is a permutation of the number sequence [1 . . . N]. In an alternate embodiment, instead of storing these pre-defined refresh patterns a number of random patterns could be generated before each estimation or refresh cycle and the process could evaluate the parameters of the random refresh patterns and select the pattern with the best perceived performance or an even just an acceptable performance based on a predetermined distortion limit.

Before a new refresh cycle is started, the distortion estimator 448 can determine a strategic refreshing pattern on line 446 for the next refresh cycle. The distortion estimator 448 can estimate the distortion for the border regions for each frame for all refresh patterns. The distortion estimator can utilize the dominating motion output from the region motion estimator 452 on line 450 and the defined refresh patterns provided by refresh pattern memory 442 to estimate the distortion. The motion vector memory 454 can store the motion vectors of the previous L frames, namely:
1. The x component of the displacement motion vector on line 436: motion_vector_memory x(est_frame, macroblock_x, macroblock_y)
2. The y component of the displacement motion vector on line 436: motion_vector_memory_y (est_frame, macroblock_x, macroblock_y) and,
3. The associated coding mode of the macroblock [‘intra-’, ‘predicted’ ] on line 420: motion_vecor_memory_mode (est_frame, macroblock_x, macroblock_y).

The motion vector memory 454 can be accessed utilizing macroblock coordinates (i.e. macroblock_x and macroblock_y) and the frame index of up to L previous frames where est_frame=1 is the last previous frame, est_frame=2 is the 2nd previous frame, and so on for est_frame=[1 . . . to . . . L]

After the refresh pattern for a new cycle is selected, the inter/intra controller 444 can determine the compression mode for each macroblock on line 420 by reading the order of refresh regions from the refresh pattern memory 442. This information can be mapped via the mapping memory 456 to the individual macroblocks provided at the multiplexer 412. The intra/inter controller 444 can control the motion estimator 434 via line 438 and prohibit prediction of frames that are under construction from utilizing old image regions to create new image regions. This control signal is not essential but can provide improved video compression. Accordingly, the intra-coded refresh pattern can be adapted to the global motion of video or the global motion of the data provided by motion estimator 434 and region motion estimator 452. Such a refresh pattern can be provided without requiring an increase in data rate. However, the present disclosure provides a system and method can achieve a low computational complexity by defining static regions for the intra-coded refresh utilizing a mapping memory to define a static set of refresh patterns while efficiently locating reference data for inter-coded transmissions.

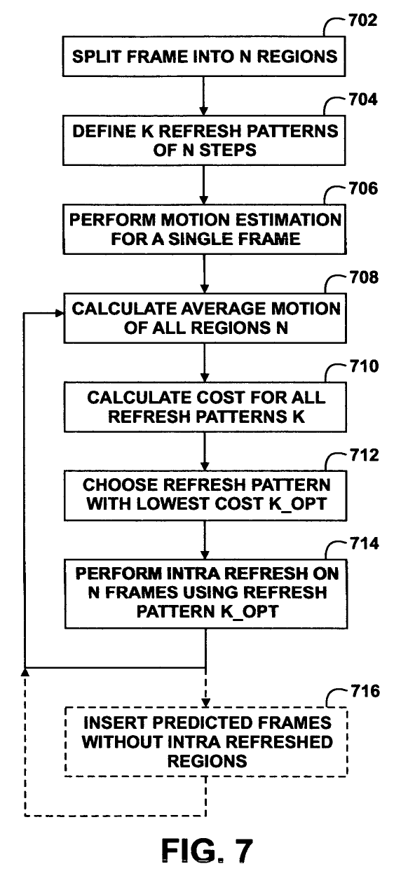

Referring to FIG. 7, a method 700 for improved video compression is provided. As illustrated by block 702, a frame can be split into N regions. K refresh patterns can be defined for the N regions as illustrated by block 704. A motion estimation calculation can be performed by a calculator for a single frame as illustrated by block 706. The average motion of all N regions can be calculated as illustrated by bock 708.

A cost or distortion parameter such as an estimated distortion at boundary regions between old and new regions can be can be calculated for all or some refresh patterns as illustrated in block 710. A refresh pattern with the lowest cost or estimated distortion can be selected as illustrated by block 712. An intra-coded refresh pattern on N frames can be performed utilizing the selected low cost refresh pattern as illustrated by block 714. The process could return to block 708, or in one embodiment the predicted frames can be inserted without intra-coded refreshed regions as illustrated by block 716 and then the process can proceed back to calculate the average motion as illustrated in block 708.

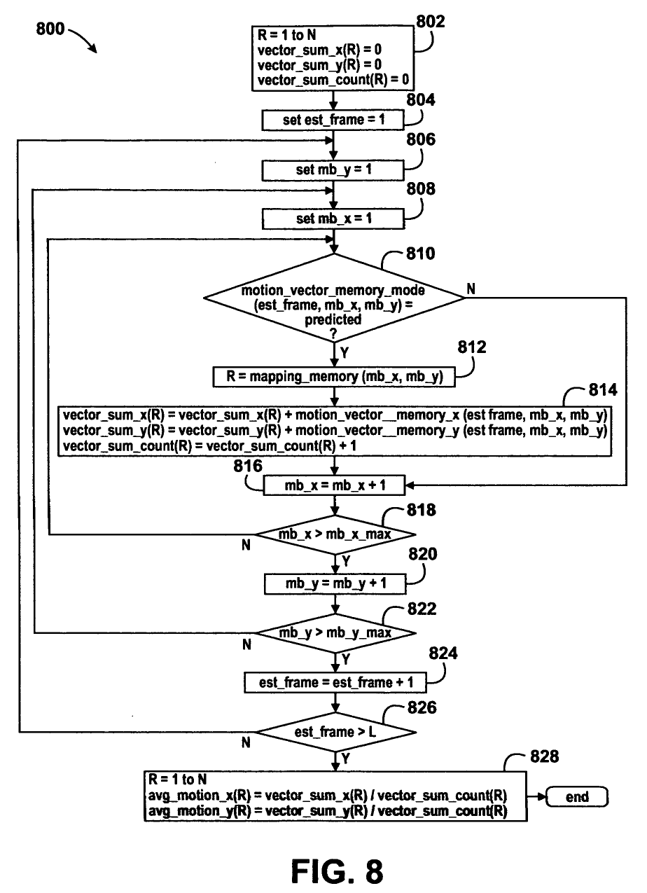

Referring to FIG. 8 a method 800 for calculating the average motion of all regions in a frame is disclosed. The flow diagram of FIG. 8 is but one way to determine motion information and other ways would not part form the scope of the present disclosure. The encoder can encode a whole frame with and intra/inter controller such as the one disclosed in FIG. 4 active. During the encoding of a frame, all calculated motion vectors can be stored in the motion vector memory, namely the x and y components of each macroblock (mb_x, mb_y), and the associated coding mode information could also be stored. When the whole frame is coded, the region motion estimator can calculate the motion for all regions. In one embodiment, macroblocks of a frame can be mapped to the appropriate region and the x and y components can be accumulated for every region in the vector_sum_x and y. At the end of the frame the vector_sum of each region can be divided by the number of vectors to calculate the average.

As illustrated in block 802 the vector sums for x, y (the macroblock directions) and the counter can be reset for all regions R. As illustrated in block, 804, the estimated frame can be set to 1, 806, the macroblock coordinates mb_y can be set to 1, and 808, mb_x can be set to 1. At decision block 810, it can be determined if motion information or motion vector information is available. In the case of an intra-coded macroblock without motion information, the method can proceed to block 816. If motion data is available, the memory map can be utilized to determine in which region the macroblock is located. The motion vector sums of the corresponding region can be assigned new values as illustrated in block 814.

As illustrated in block 816, the x macroblock coordinate can be incremented. As illustrated by decision block 818, it can be determined if the last x-macroblock of a line of macroblocks has been considered. The y macroblock coordinate can be increment as illustrated by block 820. At decision block 822, it can be determined if the last y macroblock of the frame has been considered, and if not, the value of the x macroblock can again be set to 1 as illustrated by block 808 and the process can iterate. When, at decision block 822 it is determined that all of the macroblock lines of a frame have been considered, and the estimated frame variable is less than L, then the estimated frame variable can be incremented as illustrated by block 824.

Thus, frames can be estimated from 1 to L where (est_frame=[1 . . . L]), and where est_frame=1 is the last previous frame and est_frame=2 is the 2^{nd} previous frame. When the estimated frame variable is greater than L then the average motion vector is calculated by the vector sum and the vector sum count for all regions R as illustrated in block 828. The process can end thereafter. As stated above, the average motion provided by the method of FIG. 8 can be provided to the process described in FIG. 7 namely by block 708 of FIG. 7.

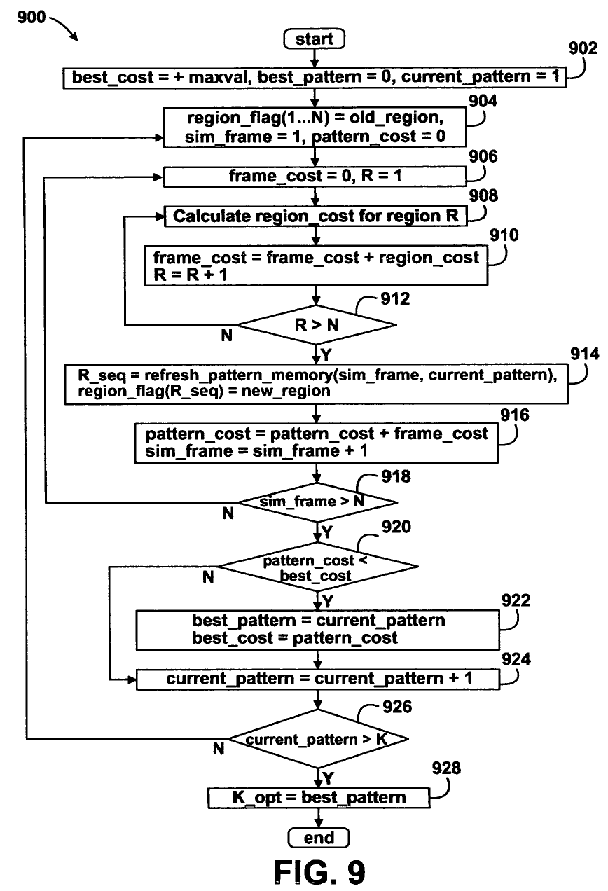

Referring to FIG. 9 a method for calculating distortion parameters and selecting a refresh pattern is disclosed. The method disclosed can be performed before transmission of a refresh cycle and the method can determine a refresh pattern from a plurality of refresh patterns that provides improved results. Based on motion information of previous frames, the method can simulate all or some pre-defined refresh patterns. For every refresh pattern, all N frames can be “tested” or sampled for distortion or for an estimated distortion. In one embodiment distortion parameters can be estimated for neighboring regions of each old frame.

As illustrated by block 902 the variables for finding the “best” pattern, can be initialized. The method can start with a current_pattern of 1 and increment until “current_patten=K” of K patterns have been tested when, as illustrated by block 926 the process can terminate.

As illustrated by block 904, the variables for the cost calculation of a single refresh pattern can be initialized. The estimation can loop over the N frames for each refresh pattern with the internal frame counter “sim_frame.” All regions can be set to old, and the pattern cost or distortion parameter can be set to zero (0). As illustrated in block 906, the frame cost calculation can be initialized. The method can loop over all regions in the frame (at decision block 912) to calculate their cost with all neighboring regions.

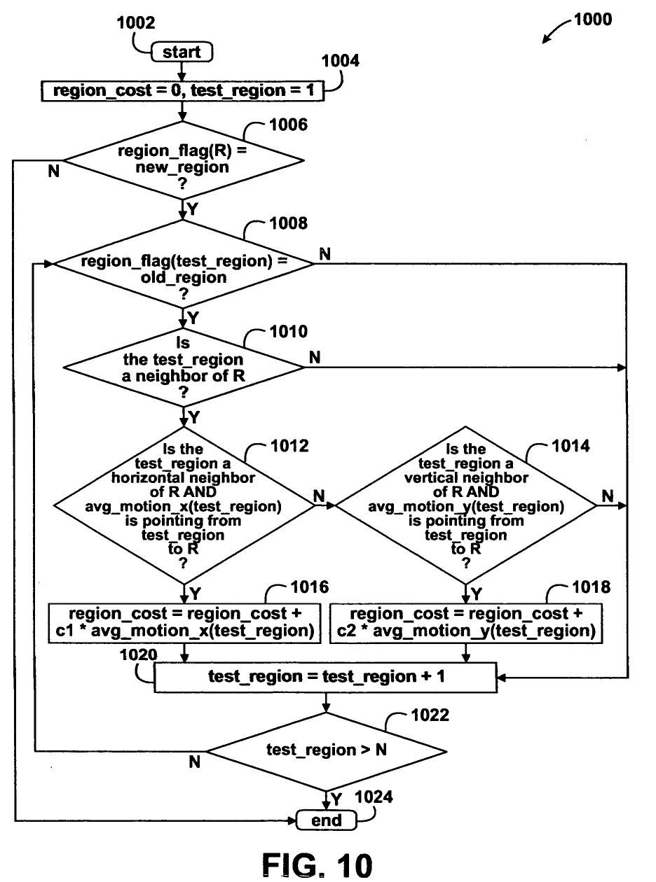

As illustrated by block 908 the subroutine disclosed in FIG. 10 below can be called to calculate the region_cost of Region R in the current loop. The frame_cost can be accumulated as illustrated in block 910, and as illustrated in block 912, the loop condition for the regions in a sim_frame can be tested. As illustrated in block 914, the simulated frame number and the index of the currently simulated pattern can be mapped through the refresh_pattern_memory in order to find out which region was intra-coded updated in the current simulated frame. Then, the region_flag for the last updated region can be set to identify it as a “new_regiom.” As illustrated in block 916, the frame_cost to pattern_cost is accumulated and the sim_frame counter is incremented. The loop condition for the simulation frame counter sim_frame can be tested as illustrated by block 918 and when all frames of the refresh pattern have been simulated the process can proceed to block 920

As illustrated by block 920 the pattern simulated can be tested to determine if the currently simulated pattern is better than the best previous pattern. If the current_pattern is an improvement over previous patterns then the index and the cost can be stored as illustrated by block 922. As illustrated by block 924 the method can increment to the next pattern. As illustrated by block 926 a loop that tests all patterns can be achieved. As illustrated by block 928 the index of the best pattern in K_opt that is passed to the inter/intra controller can be stored. Thus a “winner” refresh pattern can be located from a plurality of patterns and this pattern can be utilized at block 712 of FIG. 7.

Referring to FIG. 10, a cost calculation for a single region R in a single frame as described above is disclosed. This calculation can rely on flags that mark new regions and old regions. The flags can be set by the calling function disclosed in FIG. 9. The index of the current region is R for simplicity of illustration, and the process can loop over all regions and determine what regions are neighbors

As illustrated by block 1004, the cost can be initialized to 0 and test region can be initialized to 1. The current region can be checked to see if it is a new region as illustrated by block 1006. For old regions, the distortion parameter can be set to zero because these regions do not have to be protected or restricted. Generally the region which is to be refreshed in the current frame is still an old region and it does not contribute any protection cost as it is forcibly intra coded. Hence, the region_cost for this region can be set to zero (0) and the method can proceed with 1024.

As illustrated by block 1008 an inner loop over the test_regions is started. If in the test_region is not an “old region” as determined by block 1008, it is considered a new one. In accordance with the present disclosure new regions do not have to be protected against or restricted from new regions, so these regions can be bypassed and the process can proceeded to block 1020. As illustrated by block 1010, a test can be conducted to determine if R and the test_region are neighboring regions.

The term neighbour can be defined by referring to the description of FIG. 5 above. Referring again briefly to FIG. 5 the horizontal neighbours of region 6, are regions 5 and 7. Similarly, the vertical neighbours of region 6, are regions 2 and 10, wherein both horizontal and vertical neighbours are refereed to herein as neighbours and thus regions 2, 5, 7 and 10 are said to be neighbours of region 6. The distortion estimator (448 of FIG. 4) can determine neighbouring relationships of all regions which can be derived from the mapping memory information.

If there are horizontally adjacent regions and prediction for the old into the new region wants to be avoided, a linear distortion parameter can be accounted for as illustrated by block 1016. The constants c1 and c2 (c1, c2>0) can give the horizontal and vertical component different weighting as far as how much affect they may have. As illustrated by block 1014, a test for vertical neighbours can be conducted. If the test region is not a vertical and not a horizontal neighbour of R the process can end because distortion parameters can be ignored without a significant penalty. As illustrated by block 1020 the test_region can be implemented and a loop can continue until all test_regions with the conditions illustrated by 1022 are met The region_cost can be returned to the calling function in block 710 of FIG. 7 as illustrated by block 1024.

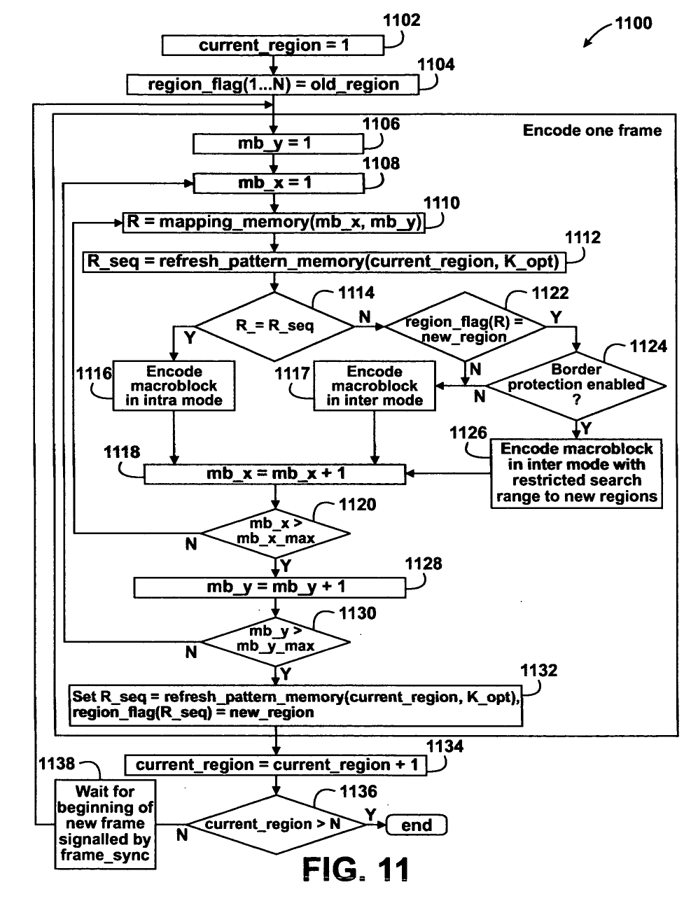

Referring to FIG. 11 a method for controlling the intra-coded refresh during the actual encoding of the video when the “optimal” refresh pattern K_opt was selected is disclosed. Although the flow diagram of FIG. 11 appears as a sequential process, it can actually be implemented where all processes run concurrently with encoding of the video frames. Macrobock x (mb_x) and macroblock y (mb_y) as well as the frame_sync inputs can be provided by some kind of external global controller and the method can determine if the current macroblock in the current frame is to be intra-coded refreshed or not.

As illustrated by block 1102, the current region can be initialized, wherein the current_region counter can count from frames 1 to N. As illustrated by block 1104 all region flags can be reset to “old regions.” This information can be utilized for restricting the search range for motion estimation for creating new regions to new regions or refreshed regions.

The x and y coordinates can be set to 1 and the coordinates can increment and loop over all macroblocks of the frame as illustrated by blocks 1106 and 1108. As illustrated by block 1110 the current macroblock can be mapped into a region and the index of the region which has to be refreshed in the current frame can be read at block 1112. As illustrated by block 1114, it can be determined if the current macroblock(mb_x, mb_y) is to be intra-coded refreshed or transmitted in predicted mode. If the current macroblock belongs to the intra-coded refresh region in the current frame the process can continue to block 1116 else the process can continue to block 1122. As illustrated by block 1116, the signal on 420 of FIG. 4 can provide an intra-coded transmission. As illustrated by block 1122 the process can check to see if the current macroblock is in the new region. If it is not in the new region it belongs to the old region and the process can encode the region with an unrestricted search range. If the current macroblock belongs to the new region the process can check for border protection

As illustrated in block 1124 the process can check to see if border protection is active or not. This refers to the enabled and disabled protection described above. If border protection is enabled, the process can continue at block 1126 and restrict the search range to new regions with signal 438 in FIG. 4. If border protection is not enabled, the macroblock can be encoded with unrestricted search range and process continues with 1117. In this case signal 438 is inactive. In one example, macroblocks inside a new region which are not on the border should not use reference data from old regions because these pixels are typically too far away to provide a good reference.

As illustrated by block 1118 the process can increment the x macroblock coordinate and as illustrated by block 1120 the macroblock x loop condition can be determined. In block 1128 the y macroblock coordinate can be incremented. As illustrated in block 1130 the macroblock y loop condition can be determined. When all macroblocks of a frame were encoded the process can continue at block 1132. As illustrated by block 1132 a region flag can be set for the region which was intra-coded in the last frame to new region. Again, the process can map the region through the refresh pattern memory. As illustrated by block 1134 the current_region counter can be incremented and the encoding of the next frame can start. As illustrated with block 1138, the process can be synchronized to the incoming video stream. This is achieved by a wait condition until the synchronization signal for the beginning of a new frame is received.

Each process disclosed herein can be implemented with a software program. The software programs described herein may be operated on any type of computer, such as personal computer, server, hand held multimedia device etc. Any programs may be contained on a variety of signal-bearing media Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present invention, represent embodiments of the present disclosure.

The disclosed embodiments can take the form of an entirely hardware embodiment, an entirely software embodiment or an embodiment containing both hardware and software elements. In one embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for refreshing a display with video data comprising:
dividing a video frame into a plurality of refresh regions;
selecting at least one priority region from the plurality of refresh regions to receive an intra-coded refresh transmission, the selecting based on a first parameter; and
transmitting the video frame, providing the intra-coded transmission to the at least one priority region.

2. The method of claim 1 wherein the first parameter comprises a distortion parameter.

3. The method of claim 1 wherein the distortion parameter is related to a calculated distortion at a boundary area between an old region and a new region.

4. The method of claim 1 further comprising enabling border protection for non-priority regions to be transmitted inter-coded data such that when a motion is in a direction of an old region, the amount of reference data from old regions utilized by the inter-coded transmission is reduced.

5. The method of claim 4 further comprising utilizing more than one frame to obtain region motion information and utilizing the motion information to reduce the effects of border protection.

6. The method of claim 4 further comprising grouping macroblocks into regions and accumulating motion data of a plurality macroblocks assigned to the region and utilizing the motion data to reduce the effects of border protection.

7. The method of claim 1 further comprising disallowing primary sources of distortion when generating inter-coded data for non-priority regions.

8. The method of claim 1 wherein the first parameter comprises a motion parameter for all regions.

9. The method of claim 1 wherein the first parameter comprises one of an overall distortion and a distortion at a boundary of at least one region.

10. The method of claim 1 wherein the parameter comprises one of a direction of motion, a global motion and a change of a dominating direction of motion.

11. The method of claim 1 further comprising:
determining a neighboring region of a border region as a new region;
determining if a dominating direction of motion is towards the neighboring region;
calculating a distortion at a border of the neighboring region and the border region; and
selecting a refresh pattern based on the distortion.

12. The method of claim 1 further comprising generating random refresh patterns before a refresh cycle, calculating a distortion on the random refresh patterns and selecting the at least one priority region based on calculation.

13. The method of claim 1 further comprising estimating a distortion parameter for neighboring regions and selecting the at least one priority region based on the estimated distortion parameter.

14. An apparatus for providing video data comprising:
an inter-coded data generator to create predictive data;
an intra-coded data generator to create refresh data;
a multiplexer to multiplex the inter-coded data with the intra-coded data;
a calculator to calculate at least one parameter of the video data;
a mapping module to mapping the video data into non-overlapping regions; and
a frame refresh controller to determine a refresh pattern of inter-coded data and intra-coded data based on the calculated at least one parameter.

15. The apparatus of claim 14, wherein the calculator is a distortion estimator and the at least one parameter is a distortion parameter.

16. The apparatus of claim 15, further comprising a region motion estimator coupled to the distortion estimator to provide motion data to the distortion estimator . . .

17. A video system comprising:
a transmitter to transmit a compressed video signal having intra-coded transmissions mapped into non-overlapping predetermined regions based on calculated parameters;
a receiver to receive the intra-coded transmissions and to decode the compressed video into a decompressed video signal.

18. The video system of claim 17 further comprising a display to display a representation of the decompressed video signal.

19. The video system of claim 17 wherein the transmitter is a wireless transmitter.

20. The video system of claim 17 wherein the compressed video signal complies with an Internet protocol standard.
